(19) United States
(12) Patent Application Publication
(10) Pub. No.: US 2008/0175726 A1
(43) Pub. Date: Jul. 24, 2008

(54) Surge Anticipator Safety Check Unit For A Liquid System

(75) Inventor: Donald L. Bartell, Beaver Falls, PA (US)

Correspondence Address: THE WEBB LAW FIRM, P.C., 700 KOPPERS BUILDING, 436 SEVENTH AVENUE, PITTSBURGH, PA, 15219, US

(73) Assignee: GA INDUSTRIES INC., Cranberry Township, PA (US)

(21) Appl. No.: 12/015,804

(22) Filed: Jan. 17, 2008

Related U.S. Application Data
(60) Provisional application No. 60/881,119, filed on Jan. 18, 2007.

(51) Int. Cl. F04B 49/00; F16L 41/00

(52) U.S. Cl. 417/279; 137/561 A

(57) ABSTRACT

A surge anticipator safety check unit for use in a liquid system for preventing damage to a pump and associated components of the system in the event of a loss in pumping pressure is provided. The unit includes a surge anticipator portion having a surge anticipator valve assembly, a hydraulic or electronic controller for operating the surge anticipator valve assembly depending on the conditions in the liquid distribution system, and a sensor associated with the controller for sensing the conditions in the downstream portion of the piping relative to the safety check unit. The surge anticipator safety check unit operates in conjunction with the operation of a check valve member in the piping and an air vacuum portion and operates to eliminate or minimize surge in the system. The valve assembly includes a solenoid plunger connected to a valve member. The plunger is operated by the controller for opening and closing the surge anticipator portion.

### CROSS REFERENCE TO RELATED PATENT APPLICATIONS

This application is based on U.S. Provisional Patent Application No. 60/881,119 filed Jan. 18, 2007, on which priority of this patent application is based and which provisional patent application is hereby incorporated by reference in its entirety.

### BACKGROUND OF THE INVENTION

1. Field of the Invention

This invention relates to a safety check unit for use in a liquid system having a pump for distributing the liquid and for protecting the equipment of the liquid system from damage associated with the loss of pumping capability. More particularly, the invention relates to a surge anticipator safety check unit having a surge anticipator portion that includes a surge anticipator valve assembly which is hydraulically or electronically controlled and operated.

2. Description of Related Art

In a liquid system, a pump is typically provided at least at one end of the liquid system so as to provide the pressure required for distributing the liquid through the system. An example of a liquid system of concern is a municipal water system where water from a reservoir, for example, is pumped through a series of water mains for eventual distribution via a liquid distribution system to homes, commercial establishments, industrial facilities, and the like. In such a municipal water system, it is prudent to protect the pump and associated equipment from damage which could occur if the pump, for whatever reason, suddenly loses head pressure and stops pumping. When such an event occurs, damage can occur to the pump, distribution manifolds, piping, and other equipment associated with the pump.

A number of conditions caused by a sudden loss of pumping pressure must be addressed within seconds of the pressure loss in order to prevent damage to the pump and associated equipment. These conditions include: 1) the presence of a negative pressure (in relation to atmospheric pressure) within manifolds, pipelines, fittings, valve bodies, etc. near the pump which potentially can cause cracking or structural failure of these components; and 2) an overpressure in the system, which potentially can cause severe structural damage to the pump, manifolds, pipeline, fittings, valve bodies etc., in the vicinity of the pump. If such conditions are not addressed properly, pockets of air can form and cause problems upon start-up of the system, including the liquid distribution system following the loss of pumping pressure.

Prior art devices or arrangements for overcoming the aforesaid conditions that tend to threaten the pump and related equipment are generally cumbersome and complex. They involve several man hours of installation, a large amount of space in the pumping station facilities, and in general, a large number of components. The large number of components needed to address a different condition such as those described above, generally require installation in different locations which tend to increase the possibility of component failure and leakage at joints that connect the piping to theses components. Mismatching the size and/or the capacity of the required components does not provide optimum protection to the liquid system. In order to match all the components to each other and to the overall system, extensive engineering analysis is required. High labor costs and the often compromised assembly of the components, under field conditions, can result in future leaks and failure of the components. The positioning of these various components of the prior art devices or arrangements at locations in the liquid system, which may not be the most beneficial location for operating the system in an optimum manner when a loss of pressure or a surge occurs, tends to compromise the liquid system.

The prior art devices or arrangements for controlling the above-listed threats to a liquid system including a liquid distribution system may include: 1) a check valve, which ideally is piped into the system immediately downstream of the pump; 2) a surge relief valve or surge anticipator valve, usually positioned at an end of a manifold in the system, but remote from the pump, for receiving and relieving the above-described back-flow surges resulting from the loss of pumping pressure; and 3) an air-vacuum valve, also usually provided at an end of a manifold or at other locations in the system remote from the pump in order to allow air into the system when negative pressure is detected so as to prevent a vacuum condition and to allow air out of the system prior to or during normal operating conditions.

In spite of the several prior art devices or arrangements, there is still a need in the art to provide a compact safety check unit associated with a liquid distribution system that overcomes the aforesaid conditions which threaten the pump and its related equipment.

### SUMMARY OF THE INVENTION

The present invention has met this need. The present invention involves a surge anticipator safety check unit for use in a liquid system that includes a liquid distribution system and which liquid system has a pump and piping downstream of the pump for distributing pumped liquid to the liquid distribution system, wherein the pump intakes a liquid at an intake pressure and outputs the liquid to the liquid distribution system at an output pressure which is greater than the intake pressure, and wherein absent action of the pump, liquid in the system exerts a surge pressure at the pump which is greater than the intake pressure. The surge anticipator safety check unit is arranged intermediate the liquid distribution system and the pump, is in liquid communication therewith, and includes a liquid checking portion for checking liquid when back-flowing from the liquid distribution system toward the pump. The surge anticipator safety check unit has an inlet port in liquid communication with the pump, an outlet port in liquid communication with the liquid distribution system, an internal chamber intermediate the inlet port and the outlet port, and a check valve member disposed in the internal chamber for preventing back-flowing of the liquid.

The surge anticipator safety check unit further includes a surge anticipator portion communicating directly with the internal chamber and configured to anticipate at least the occurrence of surges in the liquid system relative to the liquid checking portion and to relieve liquid and to reduce liquid pressure in the liquid system when the liquid pressure in the internal chamber is a pre-selected pressure less than the output pressure of the pump or a pre-selected pressure greater than the output pressure of the pump. An air input portion communicates directly with the internal chamber and is configured to provide air to the internal chamber of the liquid checking portion when the internal chamber is at least partially void of liquid and the pressure in the void is below atmospheric pressure. An air release portion communicates directly with the internal chamber and is configured to release air from the internal chamber of the liquid checking portion when liquid is in the internal chamber and the air in the internal chamber is at a pressure above atmospheric pressure.

The surge anticipator portion includes a surge anticipator valve assembly; a controller for operating the surge anticipator valve assembly depending on the conditions in the liquid distribution system; and a sensor associated with the controller for determining the conditions in the downstream portion of the piping relative to the surge anticipator safety check unit of the invention. The controller may be a hydraulic controller or an electronic controller, and the surge anticipator valve assembly includes a valve member and a plunger connected to the valve member.

The surge anticipator portion anticipates a pending surge when certain conditions are present, such as when the pump is shutting down, and also anticipates when a surge or a water hammer will contact the check valve member in the system. The surge anticipator valve assembly will open up for a preset and adjustable period of time prior to the surge hitting the check valve member or closing member in the piping and then will close. The surge anticipator portion will prevent surges from occurring and therefore will prevent damage to the components of the liquid distribution system, including the pump. The surge anticipator portion is also significantly smaller in size compared to conventional surge valves and therefore, may result in a surge anticipator safety check unit having a wider range of operating conditions compared to the prior art valve arrangements such as those described in U.S. Pat. No. 6,705,339, which is hereby incorporated by reference in its entirety.

A method of the invention provides for the protection of the components in a liquid system, such as a municipal water system or sewage system including a liquid distribution system, from damages caused by the surge pressure in the piping of the system and includes the steps of: providing a check valve member disposed in the piping downstream of a pumping assembly for preventing a back-flow of the liquid; providing a surge anticipator safety check unit between the pumping assembly and the liquid distribution system in communication with the piping and the check valve member; and sensing the pressure conditions in the system downstream relative to the surge anticipator safety check unit and operating the surge anticipator safety check unit for preventing or minimizing surge in the liquid system.

It is, therefore, an object of the present invention to provide a compact device or arrangement of components that incorporate all of the necessary features and functions for protecting a pump and the associated components of a liquid system including a liquid distribution system from structural damages generally caused by a sudden drop in pumping pressure or surge pressure in the piping of the system.

It is another object of the present invention to position the several components of a compact device or arrangement of components including the sensing means required for operation of each component of a liquid system at an optimum location in the system and to have these components configured for optimum effectiveness in preventing detrimental conditions from occurring in the liquid system.

It is yet another object of the invention to provide a device or arrangement of components being properly sized relative to each other and integrated for optimum performance and to locate the device or arrangement of components at a crucial location within a liquid system, including a liquid distribution system for optimum performance of the liquid system and/or the liquid distribution system.

It is still a further object of the invention to provide a device or arrangement of components that requires little or no human intervention from the operating personnel in order to control damage to a liquid system including a liquid distribution system and to return the device or arrangement of components to their normal operating condition after a desired pumping pressure has returned to the liquid system including the liquid distribution system.

These and other objects and advantages of the invention will become more readily apparent from the following description of the embodiments thereof which are shown, by way of example only, in the accompanying drawings.

### BRIEF DESCRIPTION OF THE DRAWINGS

FIG. 1 is a schematic diagram of a municipal water system including a water or fluid distribution system which incorporates a first embodiment of the device of the prior art;

FIG. 2 is a vertical cross-section of a first embodiment of the prior art showing components positioned as they would be during normal pumping conditions;

FIG. 3 is a vertical cross-section of the prior art device of FIG. 2 showing components positioned as they would be just following a sudden loss of pumping pressure and liquid flowing due to the momentum of the liquid;

FIG. 4 is a vertical cross-section of the prior art device of FIG. 2 showing components positioned as they would be when the liquid flowing due to momentum has stopped;

FIG. 5 is a vertical cross-section of the prior art device of FIG. 2 showing components positioned as they would be just following an initial stage of a surging back-flow of liquid;

FIG. 6 is a vertical cross-section of the prior art device of FIG. 2 showing components positioned as they would be near the end of a surging back-flow of liquid;

FIG. 7 is a vertical cross-section of a second embodiment of the prior art having an alternative surge pressure relief means;

FIG. 8 is a vertical cross-section of a third embodiment of the prior art having an alternative liquid checking portion, surge pressure relief portion, and air input/release portion;

FIG. 9 is a vertical cross-section of a fourth embodiment of the prior art having an alternative liquid checking portion, surge pressure relief portion, air input portion, and input/air release portion;

FIG. 10 is a vertical cross-section of a fifth embodiment of the prior art having an alternative liquid checking portion and air input/release portion;

FIG. 11 is a partial vertical cross-section of a sixth embodiment of the prior art invention having an alternative liquid checking portion;

FIG. 12 is a vertical cross-section of a seventh embodiment of the prior art having an alternative liquid checking portion, surge pressure relief portion, and air input/release portion; and

FIG. 13 is a vertical cross-section of a surge anticipator safety check unit of the present invention, which includes a surge anticipator valve assembly and a controller.

### DETAILED DESCRIPTION OF THE INVENTION

The present invention may be incorporated into any system where a liquid is being pumped under pressure to a distribution network, or the like, and wherein, if the pumping pressure suddenly drops, the already pumped liquid returns toward the pump under pressure as a surging back-flow. In the disclosure of the invention, terms such as upstream, downstream, and the like, are used in relation to the flow of the liquid being pumped in a direction to supply the liquid under pressure from the liquid source, and through a liquid distribution system to residential, commercial, and/or industrial users.

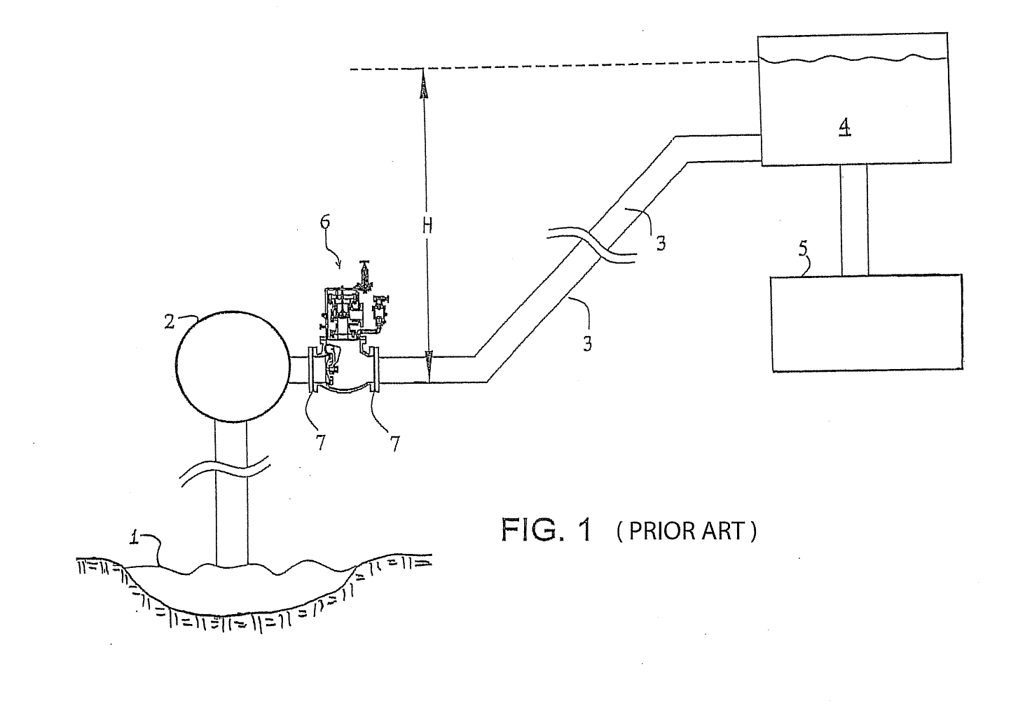

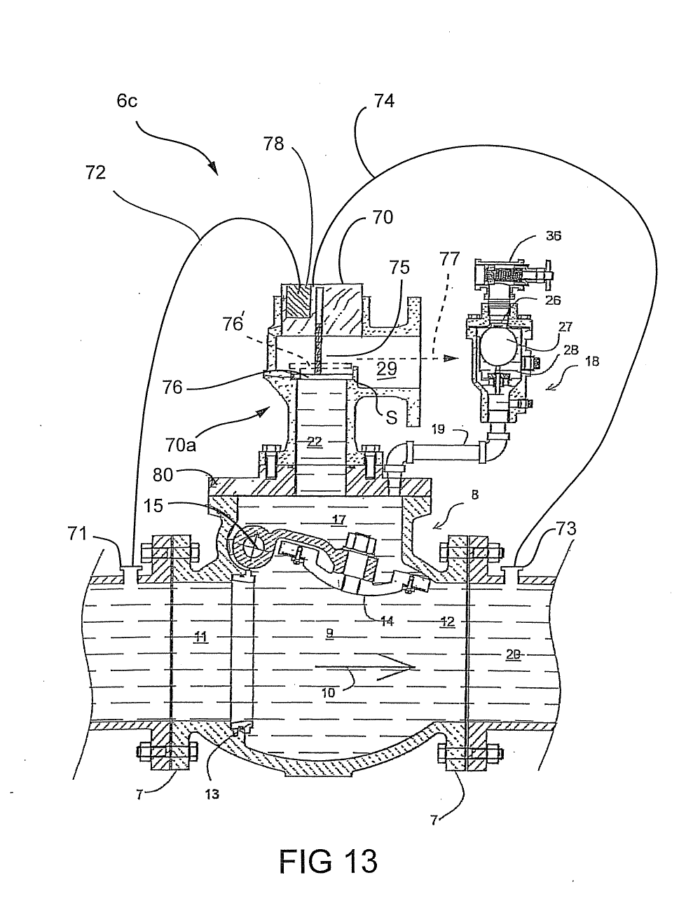

Liquid systems, which can incorporate the device, or arrangement of the present invention for protection of the components of the system, include municipal water systems, municipal sewage systems, oil or other liquid pipeline systems, and industrial processing systems. The devices of the prior art are illustrated in FIGS. 1-12 with reference to a municipal water system as disclosed in U.S. Pat. No. 6,705,339 B2. For purposes of disclosing the present invention as illustrated in FIG. 13, a discussion will first be made of the prior art devices of FIGS. 1-12 disclosed in U.S. Pat. No. 6,705,339 B2. With regard to the present invention, U.S. Pat. No. 6,705,339 B2 is incorporated herein by reference in its entirety.

FIG. 1 illustrates a municipal water system having a water source 1. Water is pumped by a water pump 2 through piping 3 to a water storage tank 4 for distribution to homes, commercial establishments, industrial facilities, and the like through distribution pipes of a municipal water distribution system 5. In such a municipal water system, the pump 2 must provide an output pressure in excess of a back pressure resulting from gravity acting on the water in any parts of the municipal water system which include all the components illustrated in FIG. 1. The amount of back pressure is dependent on the height H from the water pump 2 to the top surface of the water in the storage tank 4. It is this back pressure, which if unchecked, can cause severe damage to the pump 2 and its associated equipment of the pumping facility if a sudden drop in pumping pressure occurs. Such a sudden drop in pumping pressure can occur, for example, if electrical power to the pump 2 is interrupted. Further, when the pump 2 shuts down, a pulse or vibratory force referred to as a surge pressure may be transmitted downstream of the pump 2 which may cause damage to the other equipment located downstream of the pump 2. A safety check unit 6 is preferably installed in the municipal water system immediately downstream of the pump 2 as depicted in the schematic diagram of FIG. 1.

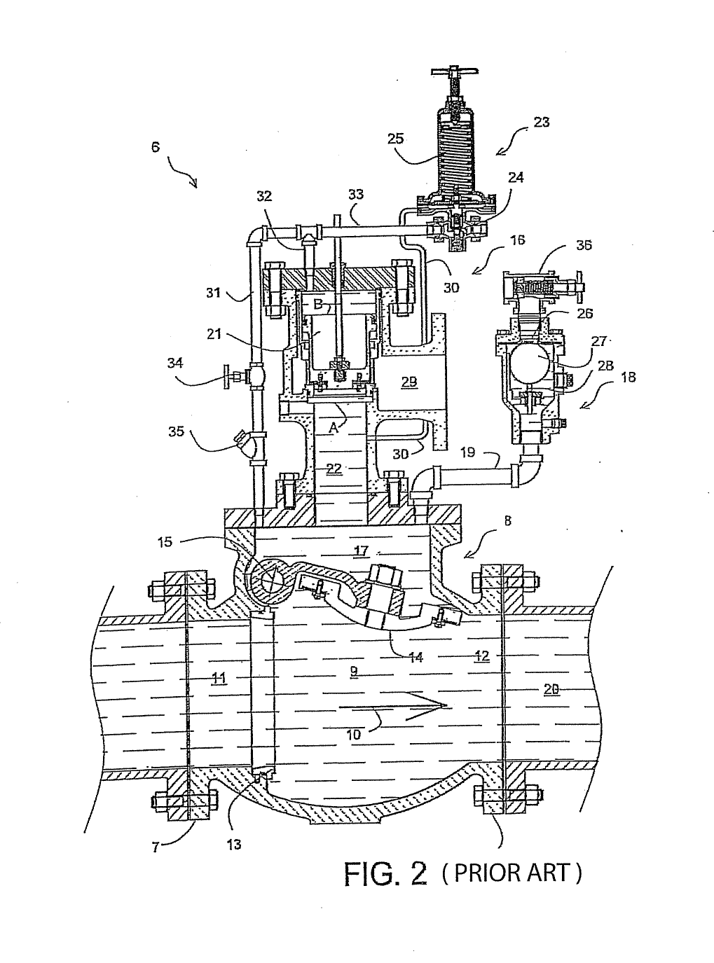

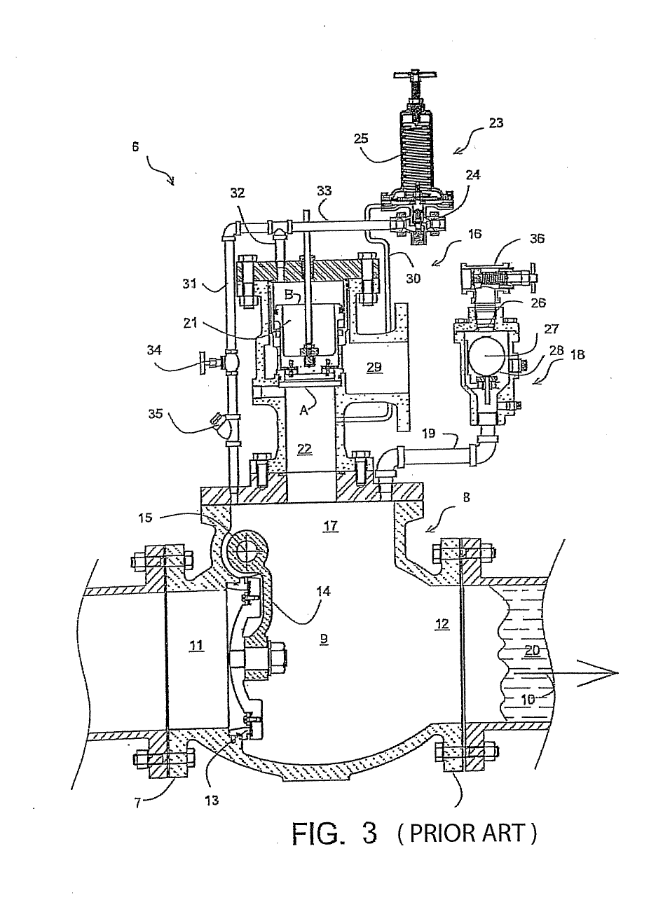

FIG. 2 shows a vertical cross-section of the safety check unit 6 of the prior art described in the aforesaid U.S. Pat. No. 6,705,339 B2. The safety check unit 6 is installed to be in direct communication with the water being pumped and is preferably installed adjacent to the pump 2 or a short distance from the pump 2 in a header, manifold, or piping 3 of the system, with use of flanges 7. A body 8 of the safety check unit 6 defines an internal chamber 9 through which the pumped water travels in a direction indicated by arrow 10 as it flows from inlet port 11 to outlet port 12. The body 8 has formed therein an annular seat 13 upon which closing member 14 pivotally closes to prevent back flowing of the water when the pumping pressure is less than the back pressure of the water fluid distribution system 5. FIG. 2 depicts the closing member 14 in an “open” position and FIGS. 3-6 depict the closing member 14 in a “closed” or “checking” position. The manner of operation of the closing member 14 is by a pivotal or swinging type movement about axis 15. Various other mechanisms for providing the checking action are possible. Additional checking actions provided by appropriate mechanisms include a piston action, a poppet action, a tilting disc action, a spring loaded action, etc.

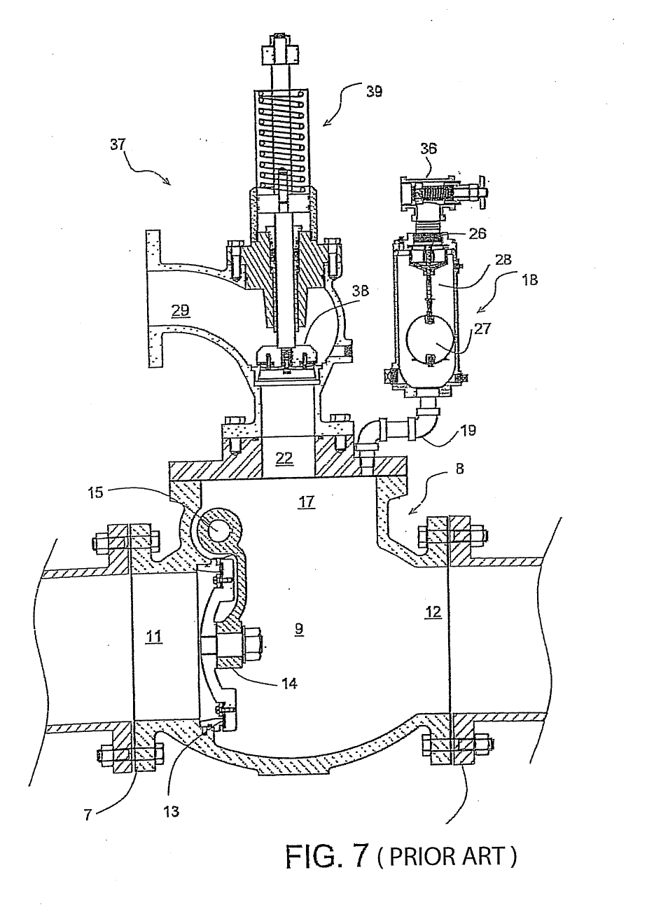

The prior art devices include other portions, which are also in direct communication with internal chamber 9. Such direct communication with internal chamber 9 provides for optimum operation of the devices and the greatest protection of the equipment of the pumping system. The other portions of the prior art devices include a surge relief portion 16 which communicates with internal chamber 9 through relief inlet port 17, and a combination air-vacuum portion 18 which communicates with internal chamber 9 through piping 19. Other embodiments of the prior art devices of FIGS. 7-12 include an air-vacuum portion having a separate air input portion and a separate air-release portion.

A sequence of events, which most likely occurs when pumping pressure is suddenly lost, is described with particular reference to FIGS. 2-6. The functions carried out by safety check unit 6, in response to those events, are also described.

FIG. 2 illustrates the safety check unit 6 in normal operation, that is, pump 2 provides a liquid pressure at the outlet port 12 which is greater then the back pressure of the liquid distribution system 5 (FIG. 1). Therefore, liquid 20 is flowing in the direction indicated by arrow 10 from inlet port 11 to outlet port 12. The force of the flowing liquid overcomes the gravitational force on closing member 14 and closing member 14 is in the open position. In normal operation, surge relief portion 16 blocks the escape of liquid by way of differential piston 21, blocking channel 22 which communicates with relief inlet port 17. A pilot valve 23, which is used to control the surge relief portion 16 having an opening 24 which is closed by the pressure of spring 25. Air-vacuum portion 18 has an opening 26 which is closed by a float assembly 27 which floats in chamber 28 in the liquid of the liquid system which fills chamber 28. With safety check unit 6 having its components positioned as described, all of the pumped liquid entering inlet port 11 exits outlet port 12 for delivery to the liquid distribution system 5 (FIG. 1) since no other liquid outlet path is open.

If a pump failure occurs, the following events may occur in the liquid system. First, the supply of liquid to inlet port 11 by the pump 2 is terminated and the entrance of liquid or air past pump 2 and into the system through inlet port 11 is blocked by the mechanism of the pump 2. Without a flow of liquid, closing member 14 drops by gravity to a position on annular seat 13 as depicted in FIG. 3.

Next, due to the momentum of the flowing (already pumped) liquid, a liquid column separation occurs whereby internal chamber 9 becomes at least partially empty of any liquid and a near vacuum condition occurs in internal chamber 9. The near vacuum condition extends partially into piping 3 (FIG. 1) or into a manifold located downstream of outlet 12 as shown in FIG. 3. Such a vacuum condition, which could have a damaging affect on the liquid system, is averted by action of the air-vacuum portion 18 of the safety check unit 6. Opening 26 is opened by movement of the float assembly 27 downward in the now liquid-depleted chamber 28 by the force of gravity, allowing air to enter internal chamber 9 by way of piping 19. Air-vacuum portion 18 allows air into the internal chamber 9 when no liquid is present in chamber 28 containing float assembly 27 and pressure in a void of internal chamber 9 is less than atmospheric pressure.

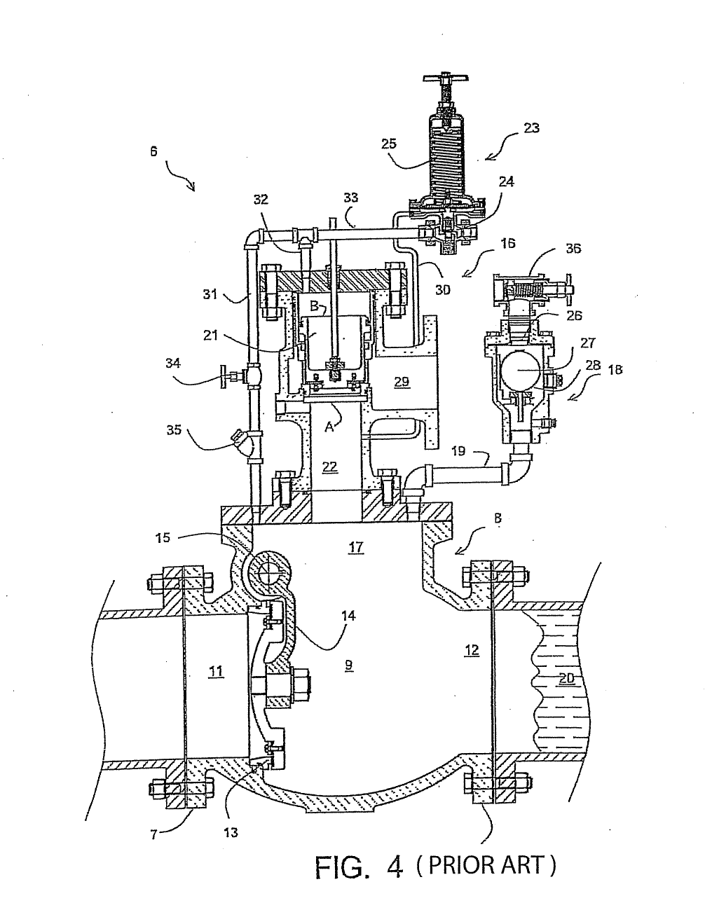

Next, as the momentum of the flowing liquid diminishes, the flow of liquid stops as depicted in FIG. 4. Closing member 14 remains against annular seat 13, air-vacuum portion 18 remains open due to float assembly 27 being displaced from opening 26, and surge relief portion 16 remains closed.

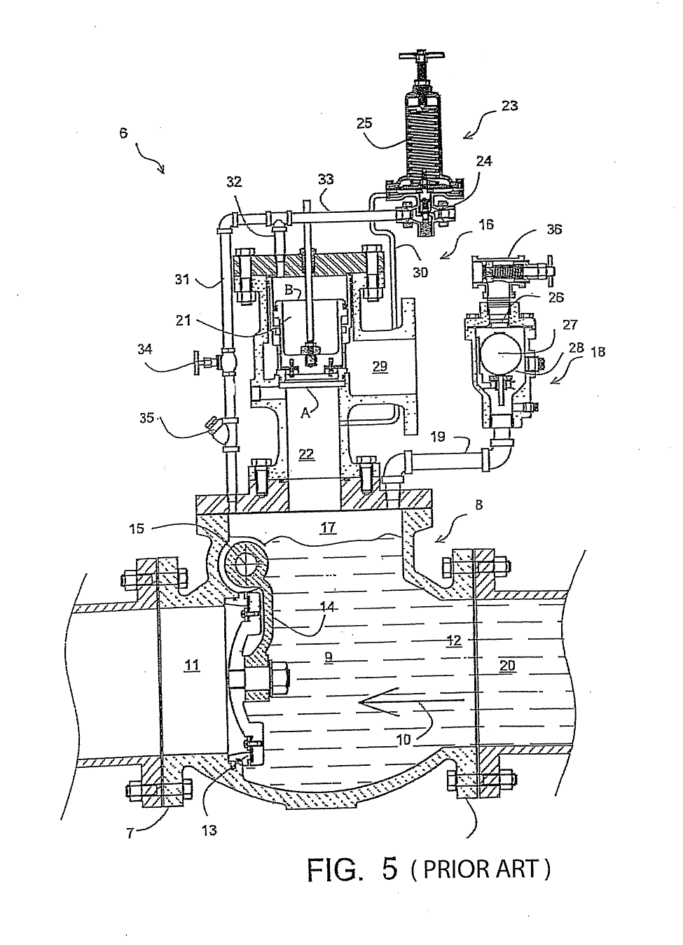

Next, the flow of liquid reverses and surges toward pump 2 as depicted in FIG. 5. Air in the system, which entered the system in order to prevent a vacuum condition, is now released from the system by way of the air-vacuum portion 18. Also, entrapped air from the liquid is released. Referring to FIG. 5, air-vacuum portion 18 has opening 26 in the open position since air is still present in chamber 28 and the float assembly 27 is not floating. Air is released by the air-vacuum portion 18 when the air is at a pressure greater than atmospheric pressure, as is the case when the liquid is back-flowing. The rate at which the air leaves the system can be restricted or regulated by a throttling device 36 which is in communication with opening 26 of air-vacuum portion 18. In addition to the float action air-vacuum valve described above, spring type and diaphragm type mechanisms can also be incorporated into the liquid system. Additionally, a weight loaded type air input mechanism can be incorporated. By releasing the air at a selected rate, the air helps to cushion the surging back-flow of liquid.

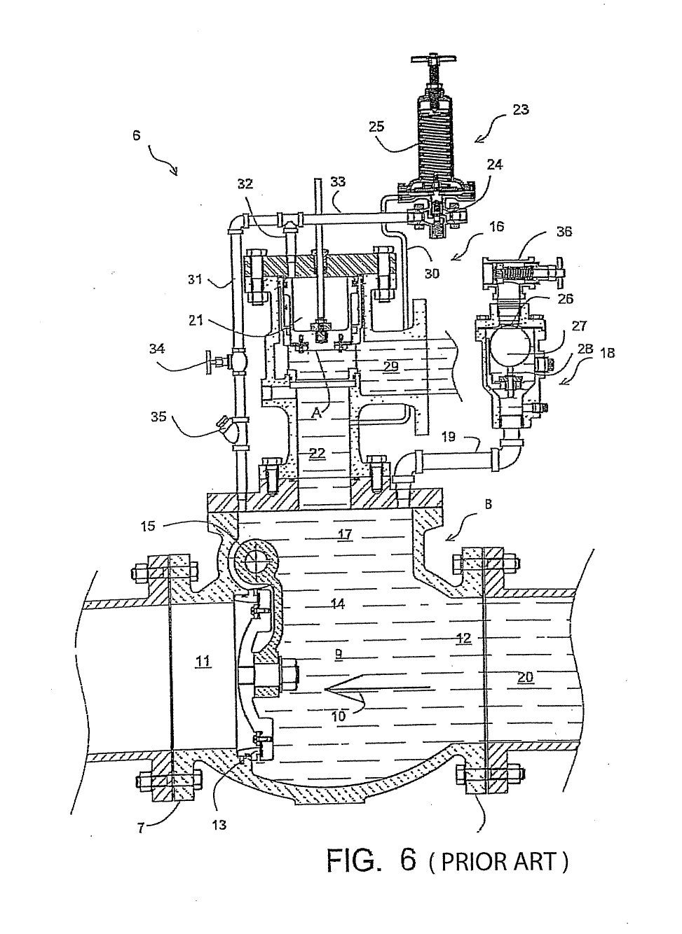

As described hereinabove, closing member 14 is closed against annual seat 13 initially by the force of gravity alone and then by the force of the back-flowing liquid. Following removal of air in the system, liquid enters chamber 28 and float assembly 27 floats to close off opening 26. The pressure in internal chamber 9 increases due to the surging back-flow of liquid. To relieve the pressure of the surging back-flowing liquid, the differential piston 21 of surge pressure relief portion 16 displaces upwardly as shown in FIG. 6 to allow the surging liquid pressure to be relieved through outlet port 29. The pressure at which differential piston 21 displaces upwardly is pre-selected and is set at a value which is greater than the normal operating pressure of the pump 2. The differential piston 21 remains upwardly displaced until the pressure in chamber 9 is less than the set pressure. A pre-selected pressure is set by means of relief pilot valve 23. Relief pilot valve 23 senses the pressure in internal chamber 9 through a sensing tube 30. During normal pumping operation of the system of FIG. 2, differential piston 21 of the surge pressure relief portion 16 has liquid of equal pressure on faces A and B as face A communicates with internal chamber 9 by way of blocking channel 22 and face B communicates with internal chamber 9 by way of piping 31 and 32. However, since face A has a smaller surface area than face B, the net force on the piston is downward, thus closing off blocking channel 22. If the pressure in chamber 9, which is conveyed to relief pilot valve 23 through sensing tube 30 increases due to the surging back-flow to a pressure above the pre-selected pressure set for relief pilot valve 23, pressure spring 25 is overcome by that pressure and valve opening 24 of the relief pilot valve 23 opens to the atmosphere so as to drop the pressure in piping 33 and 32 as well as the pressure against face B of differential piston 21. The pressure against face B is then such that the net force on differential piston 21 is in the upward direction thus allowing the surging pressure to be relieved by way of channel 22 and outlet port 29.

After the surging pressure is relieved and the pressure within internal chamber 9 becomes less than the pre-selected pressure, relief pilot valve 23 closes by action of pressure spring 25, the liquid pressure against faces A and B of differential piston 21 becomes substantially equal again, and due to the difference in surface areas of the faces A and B, the differential piston 21 is forced to the downward closed position. The speed at which differential piston 21 moves to the closed position can be controlled by closing the speed control valve 34 which meters the liquid flowing toward face B of the differential piston 21. The speed control valve 34 is preferably a needle valve, but can be any of the various means or devices available in the industry for regulating flow to control the flow of liquid in order to prevent a secondary surge of liquid from developing which could result from the differential piston 21 closing too quickly. In order to prevent clogging of speed control valve 34, a strainer 35 is preferably disposed in piping 31 ahead of speed control valve 34.

Following the closing of outlet port 29 by differential piston 21, components of the safety check unit 6 are disposed for normal pumping operation. When pumping is resumed, components of the safety check unit 6 are automatically disposed or positioned as depicted in FIG. 2, without any human intervention from the operating personnel for the liquid system.

An important feature of the safety check unit 6 of the prior art is the common chamber with which all of the portions of the safety check unit 6 directly communicate. With such direct communication, each of the actions required by the several portions of the safety check unit 6 in order to protect the pump 2 and the other components of the liquid system including the liquid distribution system 5 of FIG. 1, occurs in a very short time frame in order to provide the maximum protection to the pump 2 and its associated equipment.

A further embodiment of the prior art of FIG. 7 provides a safety check unit that has surge pressure relief that differs from that of FIGS. 1-6. Referring to FIG. 7, a surge pressure relief portion 37 relieves surging back-pressure of the liquid as described hereinabove by movement of a valve 38 in an upward direction so as to open blocking chamber 22. During normal operation of the liquid system, valve 38 is held in a closed position by spring mechanism 39. The pressure required for opening valve 38 is preselected and set by adjustment of the spring mechanism 39. In addition to the surge pressure relief valves described above, other type of action valves such as diaphragm operated, lever and weight, spring loaded action valves may be used in the safety check unit 6a of FIG. 7.

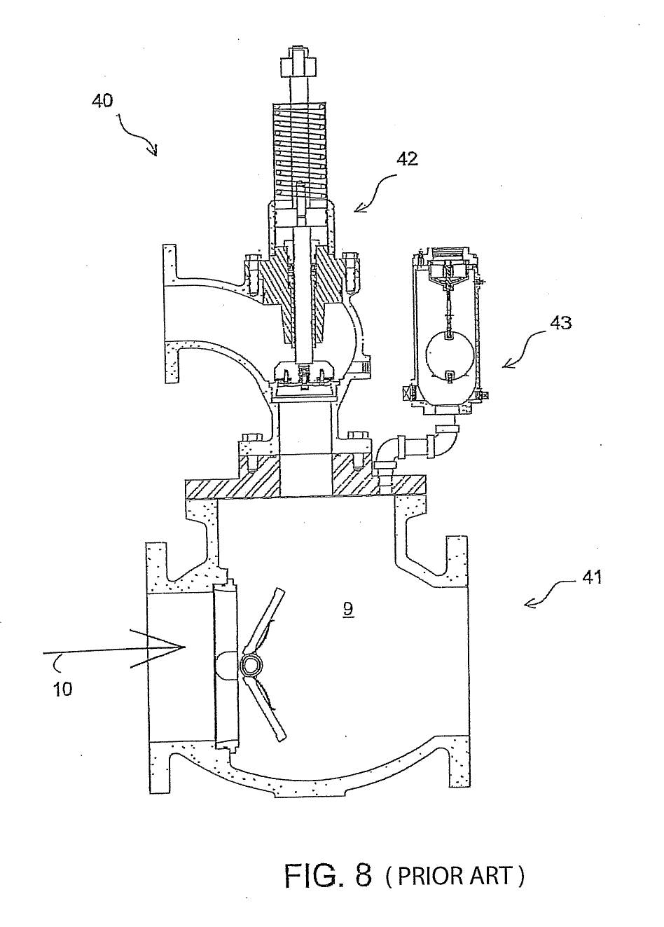

FIGS. 8-12 show further embodiments of the prior art. In FIG. 8, a safety check unit 40 incorporates a spring loaded action liquid checking portion 41, a spring loaded action surge relief portion 42 and a float action air input/air release portion 43.

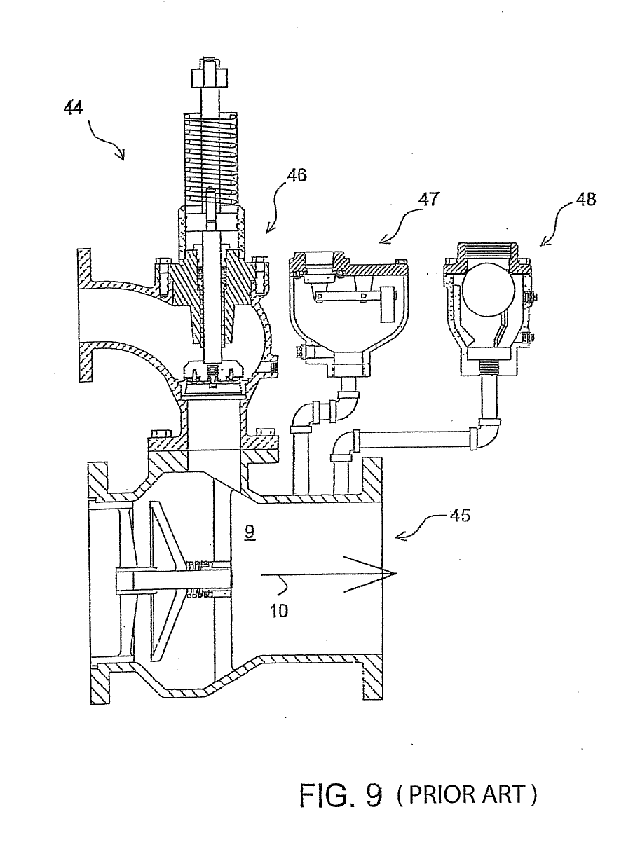

In FIG. 9, a safety check unit 44 incorporates a poppet action liquid checking portion 45, a spring loaded action surge relief portion 46, a weight loaded valve action air input portion 47, and a float action air release portion 48.

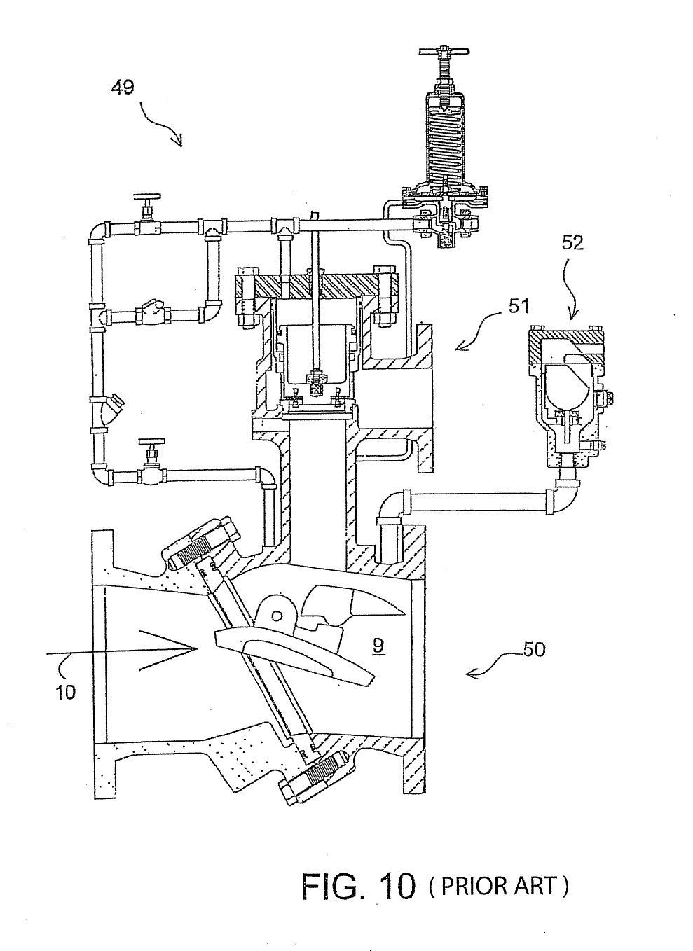

In FIG. 10, a safety check unit 49 incorporates a tilting disk action liquid checking portion 50, a piston action surge relief portion 51, and a diaphragm action air input/air release portion 52.

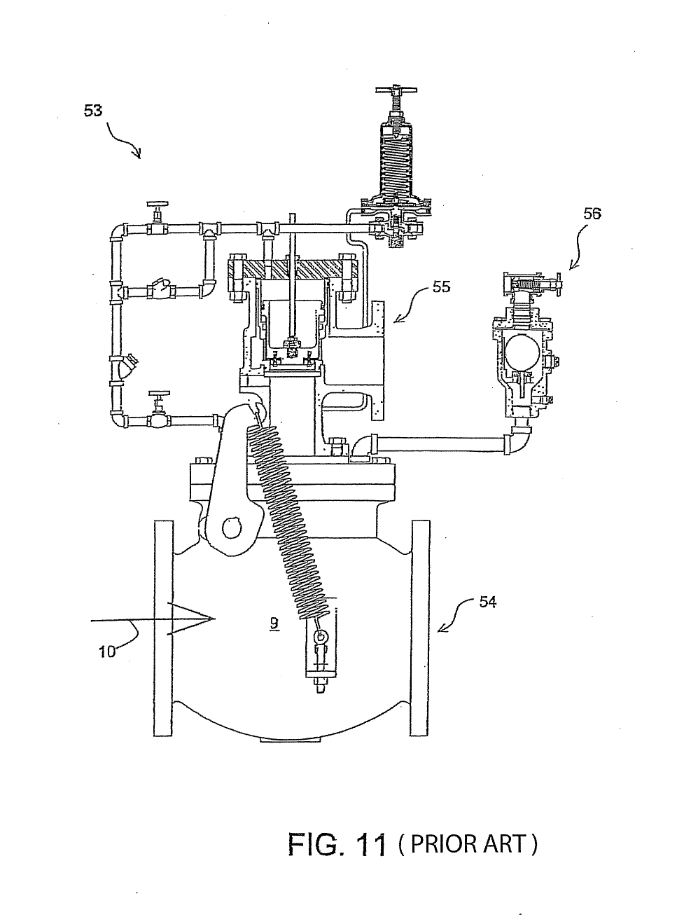

In FIG. 11, a safety check unit 53 incorporates a spring loaded action liquid checking portion 54, a piston action surge relief portion 55, and a float action air input/air release portion 56.

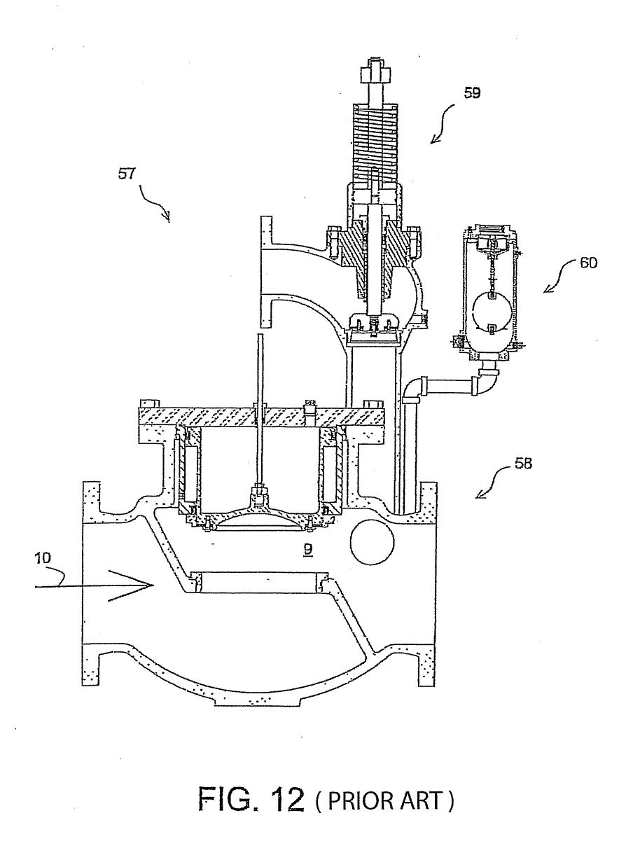

In FIG. 12, a safety check unit 57 incorporates a piston action liquid checking portion 58, a spring loaded action surge relief portion 59, and a float action air input/air release portion 60.

In the above described safety check units the liquid checking portion includes an internal chamber 9 which communicates directly with the surge relief portion, the air input portion, and the air release portion.

As stated hereinabove, FIGS. 1-12 pertain to several embodiments for a safety check unit disclosed in the above-mentioned U.S. Pat. No. 6,705,339 B2; whereas FIG. 13 pertains to a surge anticipator safety check unit of the present invention.

Referring to FIG. 13, a surge anticipator safety check unit 6c of the present invention includes a surge anticipator portion 70a, a liquid checking portion including the closing member or check valve member 14 and an air vacuum portion 18 as described hereinabove with particular reference to FIGS. 2-6. The components illustrated in FIG. 13 which have the same reference numbers as those appearing in FIGS. 2-6 are similar to these components of FIGS. 2-6. For example, the closing member or check valve member 14 and the air vacuum portion 18 of FIG. 13 are constructed and operate similar to that described with reference to FIGS. 2-6.

In the surge anticipator safety check unit 6c of the invention, the surge anticipator portion 70a includes a surge anticipator valve assembly 70, a sensor 73 for determining the conditions in the system downstream of the safety check unit 6c of the invention, and a controller 78 connected to sensor 73 via line 74 and to the surge anticipator valve assembly 70. Surge anticipator valve assembly 70 includes a valve member 76 and a plunger 75 connected to the valve member 76. The plunger 75 may be a solenoid plunger and valve member 76 may be a disc adapted to seat in a valve seat S.

Generally, the surge anticipator valve assembly 70 is in a closed state and moves to an open state when it is determined that a surge is present in the liquid system. Additionally, the surge anticipator valve assembly 70 moves to an open state when it is determined that a pulse or vibratory force is present in the system due to conditions, such as, for example, when pump 2 fails. The surge anticipator valve assembly 70 is in communication with the downstream portion of the piping 3 relative to the safety check unit 6c via sensor 73 in which information is obtained and relayed through line 74 to surge anticipator valve assembly 70. A suitable sensor may be a pressure sensor. Suitable surge anticipator valve assemblies and controller units for use in the present invention may be those manufactured by and available from GA Industries, Inc., Cranberry Township, Pa. Examples of suitable controller units 78 include the electric surge Sentinal Series Surge Anticipators for an electronic controller and the hydraulic surge Arrestor Series Anticipators for a hydraulic controller for controller unit 78.

As stated hereinabove, a condition which may exist in the liquid system containing the surge anticipator safety check unit 6c of the invention and which may cause the surge anticipator valve assembly 70 to open is when pump 2 shuts down thereby creating a pulse or vibratory force referred to as a surge in the liquid system. Surge anticipator valve assembly 70 can be an electronically or magnetically operated solenoid valve. Such a condition is sensed by sensor 73 which is located downstream from the surge anticipator safety check unit 6c. Sensor 73 generally senses pressure or other conditions which can then be used to determine the state of the fluid or liquid system downstream of the surge anticipator safety check unit 6c.

Additionally, a drop in pressure may be detected by sensor 73. Therefore, before a surge or a water hammer can contact and potentially damage the components in the system, e.g. pump 2 of FIG. 1, the surge anticipator valve assembly 70 will be actuated via controller 78 to an open position as shown in phantom at 76′ in FIG. 13. With the surge anticipator valve assembly 70 opened to the atmosphere, the harmful effects of any surge in the fluid system can be reduced by the ambient pressure present in the system.

An electronic or hydraulic controller 78 is illustrated in block form in FIG. 13 and is connected to and in associated with the surge anticipator valve assembly 70. This controller 78 generally determines which conditions sensed by sensor 73 are detrimental to the liquid system in which the surge anticipator safety check unit 6c operates and then controls the surge anticipator valve assembly 70 accordingly. For example, if sensor 73 determines an increased pressure of say 10% or more above the standard or normal operating system pressure, then the controller 78 will determine that there is a surge in the system and the valve member 76 will be opened until the pressure in the system returns to the standard or normal operating system pressure, and then close. Likewise, if sensor 73 identifies a drop of standard or normal operating system pressure of say about 70%, then the controller 78 will determine that there is a surge in the system and the valve member 76 will be opened until the pressure in the system returns to the standard or normal operating system pressure, and then close.

The surge anticipator valve assembly 70 may be opened as shown in FIG. 13 by actuating the solenoid plunger 75 which moves the valve member 76 upwardly and away from the valve seat S as shown in phantom at 76′ in FIG. 13. Once actuated, the surge anticipator valve assembly 70 will open up for a fixed period of time thereby preventing surge or water hammer from developing at the closing member 14 and allowing liquid to be released through outlet port 29, as shown by arrow 77 in phantom in FIG. 13. After the desired time has elapsed and the pressure in the system has returned to its standard or normal operating system pressure, the surge anticipator valve assembly 70 will again close by positioning valve member 76 in valve seat S to block channel 22. Accordingly, any surge or water hammer will be prevented before it can cause damage to the liquid system. Hence the surge anticipator valve assembly 70 is opened before any surge can develop in internal chamber 9.

The surge anticipator valve assembly 70 of FIG. 13 may be electronically controlled by an electronic controller or hydraulically controlled by a hydraulic controller. As discussed hereinabove, suitable electronic controllers and hydraulic controllers are available from GA Industries, Inc.

Although check valve member or closing member 14 is used in the embodiment of the present invention illustrated in FIG. 13, other types of closing members or check valve members may be used in the surge anticipator safety check unit 6c of the invention, such as, for example, those illustrated in FIGS. 8-12. The surge anticipator safety check unit 6c of the present invention detects certain conditions in the liquid system and provides protection to the liquid system against damages generally caused by a surging back-flow of liquid through anticipating detrimental conditions, e.g. a surge and/or water hammer within the system and by opening the surge anticipator valve assembly 70 before a liquid surge and/or water hammer can reach the closing member 14.

It is to be appreciated that the surge anticipator safety check unit 6c of the present invention operates in conjunction with the operation of the air vacuum portion 18 and the closing member 14, which, in turn, operate similarly to that described with reference to the embodiment of FIGS. 2-6. It is also to be appreciated that in some instances it may be necessary for the surge anticipator safety check unit 6c to have the capability to detect upstream conditions. In this instance, a sensor 71 similar to sensor 73 of FIG. 13 and connected via line 72 to controller 78 may be installed upstream of the system of FIG. 13, which would be to the left of closing member 14 and surge anticipator safety check unit 6c.

The surge anticipator safety check unit 6c of FIG. 13 may be smaller in size than conventional surge valves of the prior art. Accordingly, the surge anticipator safety check unit 6c of the invention including the surge anticipator valve assembly 70 will be afforded a wider range of use due to the reduction in space required for implementing the present invention. The prior art may be limited in its application because the larger required size of the surge valves often times does not physically fit on the cover 80 indicated in FIG. 13. The smaller required size of the surge anticipator valve assembly 70 of the invention has a better chance of being mounted on the cover 80 in a practical manner and, will therefore afford a wider range of applications.

While specific configurations of the components have been set forth for purposes of describing embodiments of the invention, various modifications can be resorted to, in light of the above teachings, without departing from applicant's novel contributions; therefore in determining the scope of the present invention, references shall be made to the appended claims.

The invention claimed is:

1. A surge anticipator safety check unit for use in a liquid system including a liquid distribution system and having a pump and piping downstream of the pump for distributing pumped liquid to the liquid distribution system, wherein the pump intakes a liquid at an intake pressure and outputs the liquid to the liquid distribution system at an output pressure which is greater than the intake pressure, and wherein absent action of the pump, liquid in the system exerts a surge pressure at the pump which is greater than the intake pressure, the surge anticipator safety check unit arranged intermediate the liquid distribution system and the pump and in liquid communication therewith and comprising:
a liquid checking portion for checking liquid when back-flowing from the liquid distribution system toward the pump and having an inlet port in liquid communication with the pump, an outlet port in liquid communication with the liquid distribution system, an internal chamber intermediate the inlet port and the outlet port, and a check valve member disposed in the internal chamber for preventing back-flowing of the liquid;
a surge anticipator portion, communicating directly with the internal chamber, configured to anticipate at least the occurrence of surges in the liquid distribution system relative to the liquid checking portion and to relieve liquid and reduce liquid pressure in the liquid distribution system when the liquid pressure in the internal chamber is at a pre-selected pressure which is greater than the output pressure of the pump or at a pre-selected pressure which is less than the output pressure of the pump;
an air input portion, communicating directly with the internal chamber, and configured to provide air to the internal chamber of the liquid checking portion when the internal chamber is at least partially void of liquid and the pressure in the void is below atmospheric pressure; and
an air release portion, communicating directly with the internal chamber, and configured to release air from the internal chamber of the liquid checking portion when liquid is in the internal chamber and air in the internal chamber is at a pressure above atmospheric pressure.

2. The surge anticipator safety check unit of claim 1, wherein said surge anticipator portion includes:
a surge anticipator valve assembly;
a controller for operating the surge anticipator valve assembly depending on the conditions in the liquid distribution system; and
a sensor associated with the controller for sensing the conditions in the downstream portion of the piping relative to the surge anticipator safety check unit.

3. The surge anticipator safety check unit of claim 2, wherein said controller of said surge anticipator valve assembly is a hydraulic controller.

4. The surge anticipator safety check unit of claim 2, wherein said controller of said surge anticipator valve assembly is an electronic controller.

5. The surge anticipator safety check unit of claim 2, wherein said surge anticipator valve assembly further includes a valve member and a plunger connected to the valve member; and wherein the plunger is operated by said controller for moving the valve member for the opening and closing of said surge anticipator portion.

6. The surge anticipator safety check unit of claim 1, wherein said check valve member of said liquid checking portion operates by a mechanism having an action selected from a swing action, a spring loaded action, a piston action, a tilting disc action, and a poppet action.

7. A liquid system including a liquid distribution system and having a pump and piping downstream of the pump for distributing pumped liquid to the liquid distribution system, wherein the pump intakes a liquid at an intake pressure and outputs the liquid to the liquid distribution system at an output pressure which is greater than the intake pressure, and wherein absent action of the pump, liquid in the liquid system exerts a surge pressure at the pump which is greater than the intake pressure, comprising:
a check valve member disposed in the piping for preventing back-flowing of the liquid; and
a surge anticipator safety check unit configured to anticipate the occurrence of surges in the liquid system and to prevent surge pressures from occurring in the liquid distribution system by relieving liquid and reducing liquid pressure in the liquid system when the liquid pressure is at a pre-selected pressure which is greater than the output pressure of the pump or at a pre-selected pressure which is less than the output pressure of the pump.

8. The liquid system of claim 7, further comprising:
an air-vacuum system configured to provide air to the piping in the area of the check valve member when the piping is partially void of liquid and the pressure in the void is below atmospheric pressure and to release air from the piping in the area of the check valve member when liquid is in this area and air in this area is at a pressure above atmospheric pressure.

9. The liquid system of claim 7, wherein said surge anticipator safety check unit is positioned in the piping between the pump and the liquid distribution system and comprises a surge anticipation portion including:
a surge anticipator valve assembly;
a controller for operation of the surge anticipator valve assembly depending on the conditions in the liquid system; and
a sensor associated with the controller for sensing the conditions in the downstream portion of the piping relative to the surge anticipator valve assembly.

10. The liquid system of claim 9, wherein said controller of said surge anticipator valve assembly is a hydraulic controller.

11. The liquid system of claim 9, wherein said controller of said surge anticipator valve assembly is an electronic controller.

12. The liquid system of claim 9, wherein said surge anticipator valve assembly further includes a plunger and a valve member operated by said controller for opening and closing said surge anticipator valve assembly.

13. A method for protecting the components in a liquid system including a liquid distribution system from damage caused by a surge pressure in the piping of the system, the steps comprising:
providing a check valve member disposed in the piping downstream of a pumping assembly for preventing back-flowing of the liquid;
providing a surge anticipator safety check unit between the pumping assembly and the liquid distribution system and in communication with the piping and the check valve member; and
sensing the pressure conditions of the system downstream relative to the surge anticipator safety check unit and operating the surge anticipator safety check unit for preventing or minimizing surge in the system.

14. The method of claim 13, the step of further providing an hydraulic controller for hydraulically controlling the operation of said surge anticipator safety check unit.

15. The method of claim 13, the step of further providing an electronic controller for electronically controlling the operation of said surge anticipator surge anticipator safety check unit.
